(19) United States
(12) Patent Application Publication
(10) Pub. No.: US 2007/0291094 A1
(43) Pub. Date: Dec. 20, 2007

(54) IMAGE FORMING APPARATUS AND PAPER DISCHARGING SYSTEM THEREOF

(76) Inventor: Karp-sik YOUN, Hwaseong-si (KR)

Correspondence Address: STANZIONE & KIM, LLP, 919 18TH STREET, N.W., SUITE 440, WASHINGTON, DC, 20006, US

(21) Appl. No.: 11/733,419

(22) Filed: Apr. 10, 2007

(30) Foreign Application Priority Data
Jun. 16, 2006 (KR) 2006-54520

(51) Int. Cl. B65H 29/20; B41J 2/01

(52) U.S. Cl. 347/104; 271/314

(57) ABSTRACT

A paper discharging system of an image forming apparatus to discharge a printed paper to the outside, includes side roller parts which are positioned on opposite sides of a paper proceeding direction and are inclined in a predetermined angle toward a vertical direction to a paper proceeding direction.

An image forming apparatus and a paper discharging system thereof enable a printing paper to be maintained stiffly in order for printing ink to be dried before transferring onto a discharging tray. Such configuration minimizes printing damage by delaying a discharge time to discharge the printed paper and prevents overlapping contact with a previously printed paper before the printing ink has sufficiently dried.

### CROSS-REFERENCE TO RELATED APPLICATIONS

This application claims priority under 35 U.S.C. §119(a) of Korean Patent Application No. 2006-0054520, filed on Jun. 16, 2006, in the Korean Intellectual Property Office, the disclosure of which is incorporated herein in its entirety by reference.

### BACKGROUND OF THE INVENTION

1. Field of the Invention

The present general inventive concept relates to an image forming apparatus and a paper discharging system thereof, and more particularly, to an image forming apparatus and a paper discharging system thereof having been improved to prevent printing damage such as smearing caused when a successively discharged printed paper come in contact with one another on a discharging tray in a state that ink on a previously discharged printed paper has to be sufficiently dried.

2. Description of the Related Art

In general, an image forming apparatus, especially an ink jet printer 10 is illustrated in FIGS. 1 and 2. The image forming apparatus includes a paper feeding device part 20 on which a printing paper P is stacked, a transferring device part 30 to transfer the printing paper P from the paper feeding device part 20, a printing device part 40 to perform printing work on the printing paper transferred by the transferring device part 30, and a paper discharging system 60 to discharge the printing paper P printed on by the printing device part 40. Also the image forming apparatus of FIG. 1 is provided with parts 50 and 70 as illustrated. Likewise, the image forming apparatus is provided with part 72 having groove 74, ledge 75 and carriage mount 48 as illustrated in FIG. 2. Also, in FIG. 2, the paper proceeding direction is the direction of the horizontal arrow illustrated.

As illustrated in FIG. 2, in the ink jet printer 10, the printing paper P stacked on the paper feeding device part 20 is elastically supported by a spring 21. The printing paper P is picked up by a pickup roller 22 and transferred to the transferring device part 30. Then, the printing paper P is transferred to the printing device part 40 by the rotation of a feed roller 31 and a friction roller 32 of the transferring device part 30. When the printing paper P is transferred from the transferring device part 30 to the printing device part 40, a head carriage assembly driving motor 45 (see illustration of FIG. 1) is operated to drive a belt 43 (see illustration of FIG. 1). Accordingly, a printing head 41 mounted to a head carriage 46 of the head carriage assembly in the printing device part 40 moves right or left along a carriage shaft 42, and jets ink on the printing paper P transferred from the transferring device part 30, thereby printing data on the paper P. The printing paper P on which data is printed by ink jetted through nozzles 41a of the printing head 41 gradually moves on a base frame 50 and reaches a paper discharging system 60. The printing paper is ultimately discharged between a paper discharging roller 61 and star wheels 62.

However, such a conventional ink jet printer 10 uses a method of jetting ink on a printing paper P so as to print a data on the printing paper P, and a successive printed paper P may be discharged (e.g., onto the previously discharged paper) before ink on the previously discharged printed paper P has been sufficiently dried. As a result, printing damage such as smearing of ink is caused because the data on the previously printed paper P comes in overlapping contact with subsequently discharged printed paper P. Accordingly, to eliminate or sufficiently reduce such smearing damage, the ink jet printer 10 needs to provide a process of drying ink for a sufficient predetermined time after printing.

As illustrated in FIGS. 3a and 3b, to solve the smearing damage problem and the annoyance of a slow drying process, an ink jet printer 10′ is designed with a guard 63 in a vicinity of a paper discharging part of the ink jet printer 10′. The guard 63 of the printer 10′ supports successive printed paper P in an inclined state until a following printed paper P is discharged so that the successive printed paper P does not immediately touch the previously discharged printed paper P. The guard 63 is designed so that the printed paper P inclined on guard 63 falls on the previously discharged printed paper P on discharging tray 64 by power generated when a subsequent printed paper P is discharged.

Such a conventional ink jet printer 10′ has an effect to prevent smear more or less by keeping the successive printed paper P from falling on the tray until ink on the printed paper P discharged on the discharging tray 64 has been adequately dried. However, because the guard is provided to on the discharging tray 64, the discharge side of the printer is too long and its volume is large. Thus, such a printer (e.g., with discharging tray 64 and guard 63) occupies too large a space to use the printer.

### SUMMARY OF THE INVENTION

The present general inventive concept provides an image forming apparatus and a paper discharging system thereof to enable a printing paper to be maintained stiffly without bending (or without bending sufficient not to contact a previously printed paper) and to be dried without falling on the discharging tray until the printed paper P is completely discharged, and especially, to minimize (or reduce) printing damage by delaying the falling time of the printed paper and optimally (or adequately) preventing overlapping contact with a previously printed paper.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a paper discharging system of an image forming apparatus to discharge a printed paper, including side roller parts which are positioned on opposite sides of a paper proceeding direction and are inclined at a predetermined angle toward with a vertical direction to a paper discharge direction.

The side roller parts may be inclined at a predetermined angle in relation to discharge a horizontal discharge direction of the printed paper.

The foregoing and/or other aspects and utilities of the present general inventive concept may be achieved by providing a paper discharging system of an image forming apparatus including a first roller part having side roller parts and a middle roller part positioned between the side roller parts.

The middle roller part may include a middle shaft and at least one middle paper discharging roller coupled to the middle shaft; and the side roller parts may include side shafts positioned on opposite sides of the middle shaft and at least one side paper discharging roller coupled to the side shafts.

The middle roller part may be connected with the side roller parts by joints.

The first roller part also may include middle supporting rollers rotating corresponding to the middle paper discharging rollers; and side supporting rollers rotating in correspondence with the side paper discharging rollers.

The middle supporting roller may include star wheels, and the side supporting rollers may include star wheels.

A paper discharging system of an image forming apparatus also may include a second roller part to transfer the printed paper to the first roller part.

The second roller part may include a second shaft; at least one second paper discharging roller coupled to the second shaft; and second supporting rollers in correspondence with the second paper discharging roller.

The second supporting rollers may include star wheels.

A first angle (between a straight line linking the outer circumference of the second paper discharging rollers with the outer circumference of the side paper discharging rollers and the paper proceeding direction) is larger than a second angle (between a straight line linking the outer circumference of the second paper discharging rollers with the outer circumference of the middle paper discharging rollers and the paper proceeding direction).

The first angle may be from about 5° to about 30°, and the second angle may be from about 0° to about 5°.

A predetermined angle from the paper proceeding direction toward the vertical direction (e.g., normal to the paper proceeding direction or normal to a horizontal surface on which the printing apparatus may be setup) may be from about 5° to about 30°.

A predetermined angle from the paper proceeding direction toward the horizontal direction may be from about 2° to about 20°.

The foregoing and/or other aspects and utilities of the present general inventive concept may be achieved by providing an image forming apparatus, may include: a base frame, and a paper discharging system to discharge a printed paper coupled to the base frame, wherein the paper discharging system includes side roller parts which are positioned on opposite sides of a paper proceeding direction and are inclined at a predetermined angle toward with a vertical direction to a paper discharge direction.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a partial perspective view of a conventional image forming apparatus.

FIG. 2 is a cross-sectional view of the image forming apparatus illustrated in FIG. 1.

FIGS. 3A and 3B are perspective views of a paper discharging tray of a conventional image forming apparatus.

FIGS. 4A and 4B are a perspective view and side view, respectively, of a main frame of an image forming apparatus including a paper discharging system according to an embodiment of the present general inventive concept.

FIG. 5 is perspective view of the paper discharging system illustrated in FIG. 4, according to an embodiment of the present general inventive concept.

FIG. 6 is a plan (top) view of the paper discharging system illustrated in FIG. 5, pursuant to an embodiment of the present general inventive concept.

FIG. 7 is a front cross-sectional view of the paper discharging system illustrated in FIG. 5, according to an embodiment of the present general inventive concept.

FIGS. 8A and 8B are side views of the paper discharging system illustrated in FIG. 5, pursuant to an embodiment of the present general inventive concept.

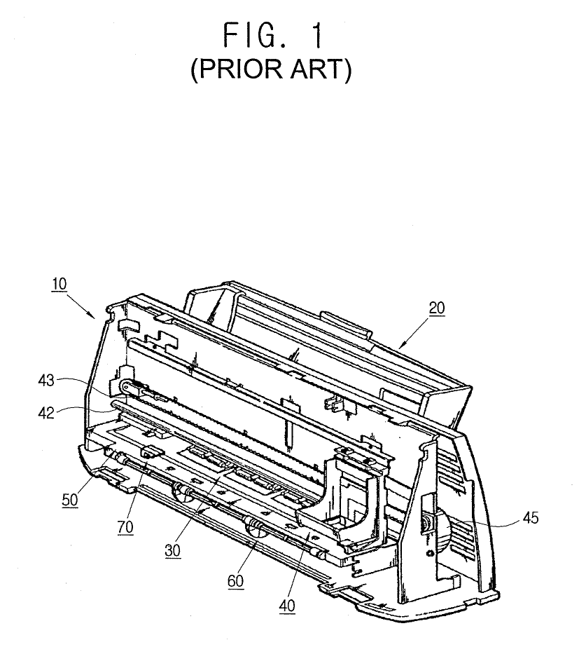

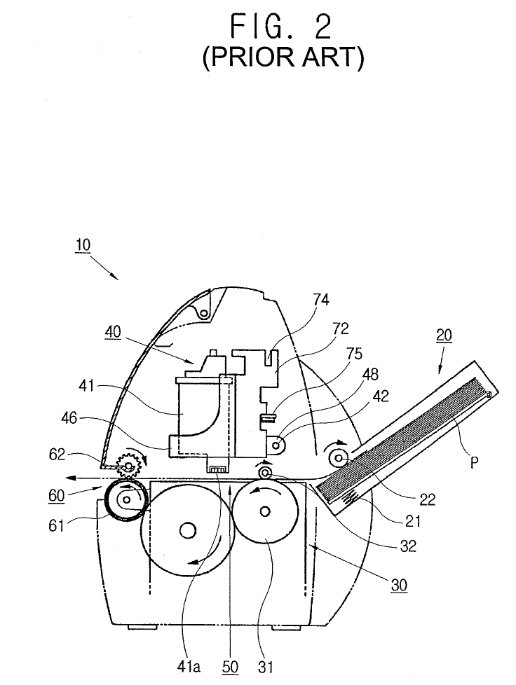

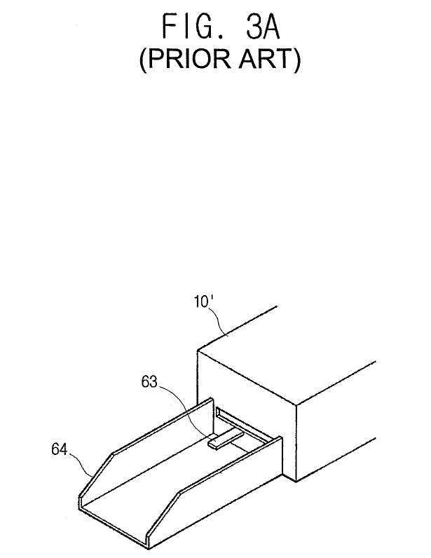

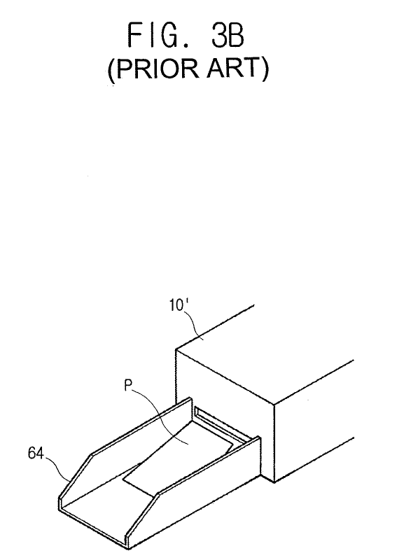

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below so as to explain the present general inventive concept by referring to the figures.

The same elements are given the same reference numerals in various embodiments, and they will be typically described in an embodiment of the present general inventive concept, and may be omitted in the other embodiments of the present general inventive concept.

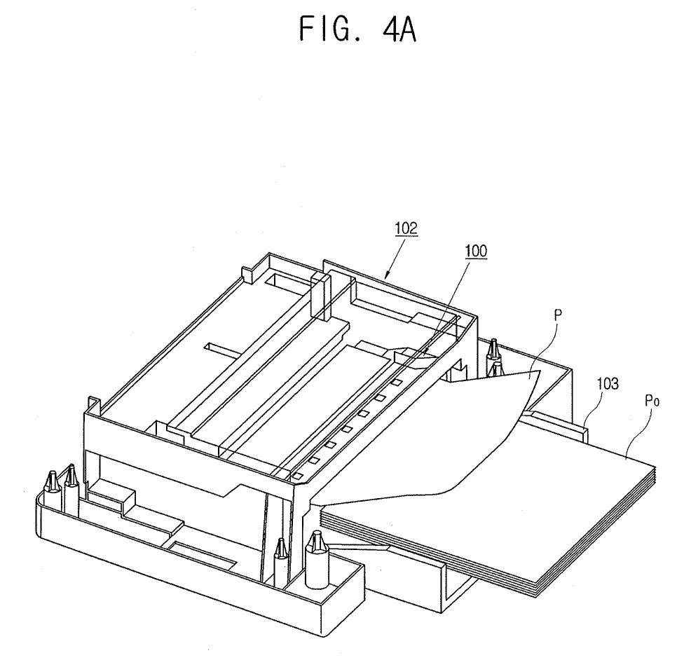

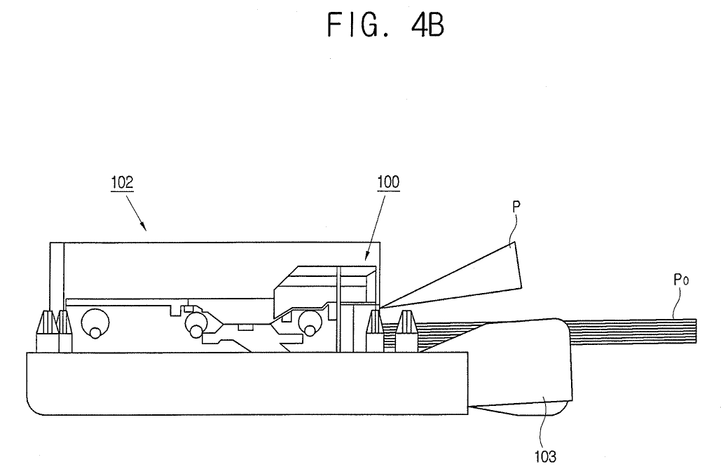

As illustrated in the embodiments of FIGS. 4A and 4B of the present general inventive concept, an image forming apparatus includes a base frame 102 and a paper discharging system 100 coupled to the base frame 102.

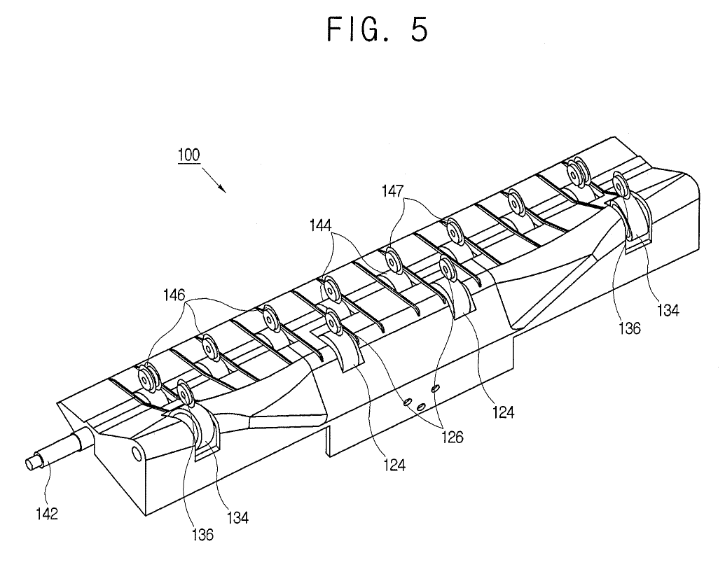

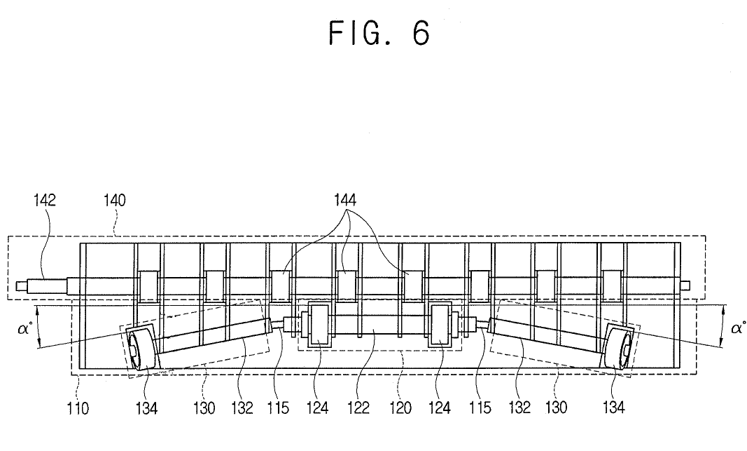

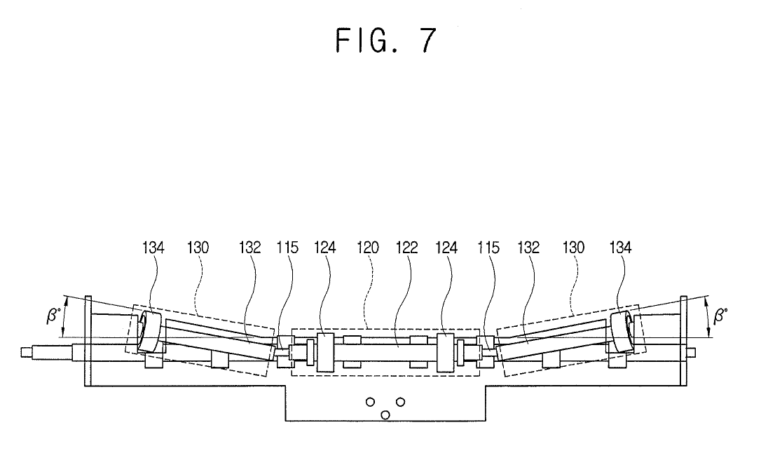

As illustrated in the embodiments of FIGS. 5 and 6 of the present general inventive concept, the paper discharging system 100 includes a first roller part 110, and a second roller part 140. The second roller part 140 transfers a printed paper P printed by a printing head (not illustrated) to the first roller part 110. The first roller part 110 which may be inclined at predetermined angles α and β (refer to the embodiments of FIGS. 6 and 7 of the present general inventive concept) with respect to a paper proceeding direction may bend the printed paper P passing over the second roller part 140. The first roller part 110 ultimately discharges the printed paper P discharges it to an outside thereof.

Referring to FIG. 5, the second roller part 140 may include a second shaft 142 connected with a gear (not illustrated) driven at a regular set speed by a motor (not illustrated), a plurality of second paper discharging rollers 144 installed in the second shaft 142 at predetermined intervals, and a plurality of second supporting rollers 146 positioned to rotate with respect to the second paper discharging rollers 144 to transfer rotating power of the second paper discharging rollers 144 to the printed paper P. The second shaft 142 may be transversely positioned on a second accommodating part (not illustrated) formed in the base frame 102 with the second paper discharging rollers 144. The second supporting rollers 146 may be coupled to a second supporting shaft (not illustrated) positioned to rotate with respect to a holder (not illustrated) and positioned in the base frame 102 at predetermined intervals to correspond to the position of the second paper discharging rollers 144. Accordingly, when the second shaft 142 is rotated by the gear connected to the motor, the second paper discharging rollers 144 transfer the printed paper P printed by a printing head to the first roller part 110 in cooperation with the second supporting rollers 146. The second supporting rollers 146 may include star wheels 147 in which saw teeth are formed along an outer circumference to impinge with the second supporting rollers 146 so as to minimize a trace caused by the second supporting rollers 146 while transferring the printed paper P to the first roller part 110.

As illustrated in the embodiment of FIGS. 5, 6 or 7 of the present general inventive concept, the first roller part 110 includes a middle roller part 120 positioned in the middle of a width direction of the printed paper P, and a side roller part 130 respectively connected with joints 115 on opposite sides of the middle roller part 120. The middle roller part 120 and the side roller part 130 respectively include at least one middle paper discharging roller 124 coupled to a middle shaft 122 at a predetermined interval, and at least one side paper discharging roller 134 coupled to side shafts 132 at a predetermined interval. Also, as illustrated in the embodiment of FIG. 5 of the present general inventive concept, on the middle paper discharging rollers 124 and the side paper discharging roller 134 are positioned middle supporting rollers 126 and side supporting rollers 136 respectively in contact with the middle paper discharging rollers 124 and the side paper discharging rollers 134 to transfer rotating power of the middle paper discharging rollers 124 and the side paper discharging rollers 134 to the printed paper P. The middle supporting rollers 126 and the side supporting rollers 136 may cooperate with star wheels 147 in which saw teeth are formed to impinge the printed paper P with the circumference of the middle supporting rollers 126 and the circumference of the side supporting rollers 136 to minimize a trace caused by the middle supporting rollers 126 and the side supporting rollers 136 while transferring the printed paper P. The middle shaft 122 and the side shafts 132 may be respectively positioned transversely on a first accommodating part (not illustrated) formed in the base frame 102 with the middle paper discharging rollers 124 and the side paper discharging rollers 134. The middle supporting rollers 126 and the side supporting rollers 136 may be respectively coupled to a middle supporting shaft (not illustrated) and a side supporting shaft (not illustrated) positioned on a holder (not illustrated) fixed on the base frame 102. The rollers 126 and 136 may be positioned at one or more predetermined intervals.

As illustrated in the embodiment of FIG. 6 of the present general inventive concept, the side roller parts 130 are positioned on opposite sides of the middle roller part 120 inclined at a predetermined angle α in a horizontal direction corresponding with the paper proceeding direction so that the printed paper P can be maintained without being bent (e.g., downward in a direction transverse to the horizontal direction) until the printed paper P is transferred from the second roller part 140. According to an embodiment of the present general inventive concept, the inclined angle α between the middle roller part 120 and the side roller parts 130 may independently be from about 5° to about 30°.

As illustrated in the embodiment of FIG. 7 of the present general inventive concept, the side roller parts 130 are positioned on opposite sides of the middle roller part 120 and inclined in a predetermined angle β toward a vertical direction in relation to the paper proceeding direction. Then, the side roller parts 130 may bend up the opposite sides of the printed paper P with respect to the paper proceeding direction to maintain the paper in a sufficiently stiff state without being bent (e.g., downward) onto discharging tray 103 until the printed paper P transferred from the second roller part 140 is completely discharged. According to an embodiment of the present general inventive concept, the inclined angle β between the middle roller part 120 and the side roller parts 130 may be from about 2° to about 20°.

Also, the middle shaft 122 of the middle roller part 120 and the side shafts 132 of the side roller parts 130 may be coupled to each other by joints 115 to enable the middle shaft 122 and the side shafts 132 to cooperatively rotate, according to an embodiment of the present general inventive concept.

The joint 115 may be provided as a universal joint but may also include bevel gears to couple the middle shaft 122 and the side shafts 132.

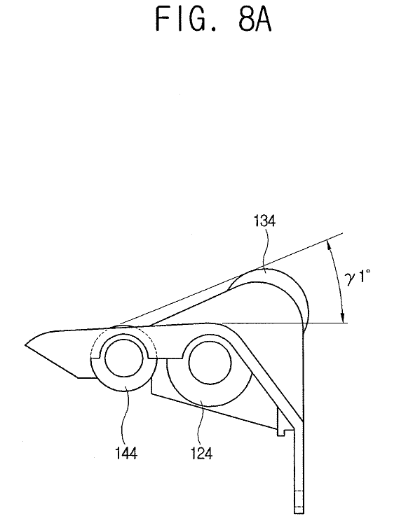

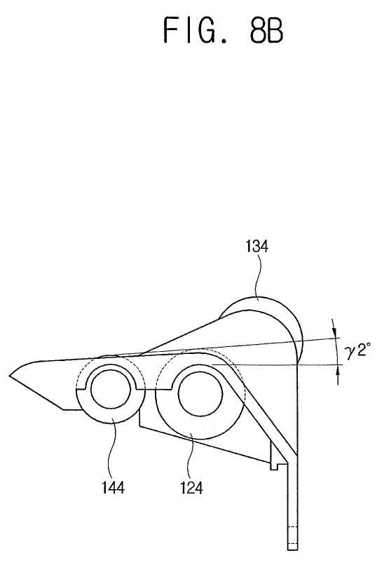

As illustrated in the embodiment of FIGS. 8a and 8b of the present general inventive concept, a first angle γ1 (between a straight line linking the outer circumference of the second paper discharging rollers 144 with the outer circumference of the side paper discharging rollers 134 of the side roller parts 130 and with the paper proceeding direction) may be larger than a second angle γ2 (between a straight line linking the outer circumference of the second paper discharging rollers 144 with the middle paper discharging rollers 124 of the middle roller part 120 and the paper proceeding direction). According to an embodiment of the present general inventive concept, the first angle γ1 may be from about 5° to about 30°, and the second angle γ2 may be from about 0° to about 5°. Thus, the side roller parts 130 bends the opposite sides of the printed paper P upwards so that the printed paper P can be maintained stiffly until the printed paper P may be completely (or nearly completely) transferred from the second roller part 140, according to an embodiment of the present general inventive concept.

As described in the foregoing embodiments of the present general inventive concept, the image forming apparatus and especially, the paper discharging system 100 of an ink jet printer is designed to prevent printing damage (e.g., smearing) by maintaining the printed paper P stiffly (without being bent by its own stiffness) and preventing the printed paper from directly falling on a discharging tray 103 until the printed paper is completely discharged over the first roller part 110.

In the image forming apparatus with the above configuration, an operation of the paper discharging system 100 will be described with reference to the embodiments of FIGS. 4a through 8b of the present general inventive concept as follows.

The printed paper P on which data is printed (e.g., by ink jetted from nozzles of a printing head) gradually moves on the base frame 102 to reach the second roller part 140. After reaching the second roller part 140, the printed paper P is transferred to the first roller part 110 through the second supporting rollers 146 and the second paper discharging rollers 144 rotated by an operation of a motor connected with the second shaft 142. The opposite sides of the printed paper P which has reached the first roller part 110 is bent upwardly by the middle roller part 120 and the side roller parts 130 getting rotating power from a second shaft 142. The opposite sides of the paper are bent upward toward a vertical direction in relation to the horizontal paper proceeding direction of the middle width direction of the printed paper P, pursuant to an embodiment of the present general inventive concept.

Because the opposite sides of the printing paper P are upwardly bent, the paper is maintained in a stiff state, and does not fall downward as shown in FIG. 4A until the end side of the printed paper P is discharged through the first roller part 110. Accordingly, the previously printed paper (P₀) and ultimately discharged on the discharging tray 103 has sufficient time to adequately dry the ink while the printed paper P is maintained in the stiff state. That is, until the printed paper P is completely discharged over or from the first roller part 110, according to an embodiment of the present general inventive concept.

As described, pursuant to an embodiment of the present general inventive concept, after the printed paper P is completely discharged through the first roller part 110, the printed paper P falls on discharging tray 103 and may be collected thereon.

Also, pursuant to an embodiment of the present general inventive concept, side roller parts 130 may be provided in the shape of V without the middle roller part 120.

As described above, according to one or more embodiments of the present general inventive concept, there is provided an image forming apparatus, and especially an ink jet printer in which the printed paper does not fall on the discharging tray and is provided sufficient time to dry ink printed thereon while being maintained stiffly (e.g., without being bent downward such by stiffness) until the paper is completely (or sufficiently) discharged. Especially, because the side roller part is inclined toward a vertical direction to the paper proceeding direction (e.g., cupped upwards), it optimally delays time for the printed paper to fall downward, to prevent printing damage (such as smearing) caused by overlapping contact with the previously printed paper before the printing ink has had sufficient time to adequately dry.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A paper discharging system of an image forming apparatus to discharge a printed paper, comprising:
side roller parts which are positioned on opposite sides of a paper proceeding direction and are inclined at a first predetermined angle toward a vertical direction relative to a paper proceeding direction.

2. The paper discharging system of claim 1, wherein the side roller parts are inclined at a second predetermined angle toward a horizontal direction relative to the paper proceeding direction.

3. The paper discharging system of claim 2, further comprising:
a first roller part having the side roller parts; and
a middle roller part positioned between the side roller parts.

4. The paper discharging system of claim 3, wherein:
the middle roller part comprises a middle shaft and at least one middle paper discharging roller coupled to the middle shaft; and
the side roller parts comprise side shafts positioned on opposite sides of the middle shaft and at least one side paper discharging roller coupled to the side shafts.

5. The paper discharging system of claim 4, wherein the middle roller part is connected with the side roller parts by joints.

6. The paper discharging system of claim 5, wherein the first roller part further comprises:
at least one middle supporting roller to rotate in correspondence with the at least one middle paper discharging roller; and
a side supporting roller to rotate in correspondence with the at least one side paper discharging roller.

7. The paper discharging system of claim 6, wherein:
the at least one middle supporting roller comprises a star wheel; and
the side supporting roller comprises a star wheel.

8. The paper discharging system of claim 7, further comprising:
a second roller part to transfer the printed paper to the first roller part.

9. The paper discharging system of claim 8, wherein the second roller part comprises:
a second shaft;
at least one second paper discharging roller coupled to the second shaft; and
a second supporting roller to rotate in correspondence with the at least one second paper discharging roller.

10. The paper discharging system of claim 9, wherein the second supporting roller comprises a star wheel.

11. The paper discharging system of claim 9, wherein a first angle between the paper proceeding direction and a straight line linking an outer circumference of the second paper discharging roller with an outer circumference of the side paper discharging roller is larger than a second angle between the paper proceeding direction and a straight line linking the outer circumference of the second paper discharging roller with an outer circumference of the middle paper discharging roller.

12. The paper discharging system of claim 11, wherein the first angle is from about 5° to about 30°, and the second angle is from about 0° to about 5°.

13. The paper discharging system of claim 1, further comprising:
a first roller part including a middle roller part positioned between the side roller parts.

14. The paper discharging system of claim 13, wherein:
the middle roller part comprises a middle shaft and at least one middle paper discharging roller coupled to the middle shaft; and
the side roller parts comprise side shafts positioned on opposite sides of the middle shaft and at least one side paper discharging roller coupled to the side shafts.

15. The paper discharging system of claim 14, wherein the middle roller part is connected with the side roller parts by joints.

16. The paper discharging system of claim 15, wherein the first roller part further comprises:
at least one middle supporting roller to rotate in correspondence with the at least one middle paper discharging roller; and
a side supporting roller to rotate in correspondence with the at least one side paper discharging roller.

17. The paper discharging system of claim 16, wherein:
the at least one middle supporting roller comprise a star wheel, and
the side supporting roller comprises a star wheel.

18. The paper discharging system of claim 17, further comprising:
a second roller part to transfer the printed paper to the first roller part.

19. The paper discharging system of claim 18, wherein the second roller part comprises:
a second shaft;
at least one second paper discharging roller coupled to the second shaft; and
a second supporting roller rotating in correspondence with the at least one second paper discharging roller.

20. The paper discharging system of claim 19, wherein the second supporting roller comprises a star wheel.

21. The paper discharging system of claim 19, wherein a first angle between the paper proceeding direction and a straight line linking an outer circumference of the second paper discharging roller with an outer circumference of the side paper discharging roller is larger than a second angle between the paper proceeding direction and a straight line linking the outer circumference of the second paper discharging roller with an outer circumference of the middle paper discharging roller.

22. The paper discharging system of claim 21, wherein the first angle is from about 5° to about 30°, and the second angle is from about 0° to about 5°.

23. The paper discharging system of claim 1, wherein the first predetermined angle toward the vertical direction relative to the paper proceeding direction is from about 2° to about 20°.

24. The paper discharging system of claim 2, wherein the second predetermined angle along the horizontal direction relative to the paper proceeding direction is from about 5° to about 30°.

25. An image forming apparatus, comprising:
a base frame, and a paper discharging system to discharge a printed paper, comprising side roller parts which are positioned on opposite sides of a paper proceeding direction and are inclined at a first predetermined angle toward a vertical direction relative to a paper proceeding direction.

26. An image forming apparatus comprising:
a base frame to guide and discharge a print medium in a discharging direction; and
a discharging system having a roller part disposed in a direction to receive the discharged print medium along the discharging direction, and another roller part disposed in a second direction having an angle with the direction of the roller part to receive the print medium from the roller part to feed the print medium in a second discharging direction having an angle with the discharging direction.

27. The image forming apparatus of claim 26, wherein the another roller part comprises a middle roller part disposed parallel to the roller part and side roller parts disposed opposite to each other with respect to the middle roller part in the second direction.

28. The image forming apparatus of claim 26, wherein the another roller part comprises a middle roller to rotate about an axis parallel to the first direction and a side roller to rotate about another axis having the angle with the axis.

29. The image forming apparatus of claim 26, wherein:
the print medium has a width in the direction; and
the another roller part comprises side rollers disposed apart from each other by a second width narrower than the width.

30. The image forming apparatus of claim 26, wherein the angle between the direction and the another direction is determined according to at least one of a size and a material of the print medium.

31. The image forming apparatus of claim 26, wherein the another roller part and the roller part are spread apart by a distance determined according to a width of the print medium.

32. The image forming apparatus of claim 26, wherein the direction and the another direction meet a portion of the roller part, and the portion of the roller part is not a middle of the roller part.

33. The image forming apparatus of claim 26, wherein the roller part comprises a first number of rollers disposed in the direction and the another roller part comprises a second number of rollers disposed in the second direction.

34. An image forming apparatus comprising:
a base frame to guide a print medium;
a first roller part formed on a first portion of the base frame and disposed in a direction to receive the guided print medium to discharge the print medium in a discharging direction; and
another roller part formed on a second portion of the base frame to receive the discharged print medium from the first roller part to bend a portion of the received print medium.

35. The image forming apparatus of claim 34, wherein the portion of the print medium is a side of the print medium to be bent with respect to a middle of the print medium.
